(19) United States
(12) Patent Application Publication
(10) Pub. No.: US 2026/0001512 A1
(43) Pub. Date: Jan. 1, 2026

(54) ADAPTIVE CLIMATE CONTROL BASED ON THERMAL IMAGING AND PHYSIOLOGICAL STATES OF A USER

(71) Applicant: Adeia Guides Inc., San Jose, CA (US)

(72) Inventors: Evgeny Kaminsky, Hallandale Beach, FL (US); Reda Harb, Tampa, FL (US); Christopher Phillips, Hartwell, GA (US); Tao Chen, Palo Alto, CA (US)

(21) Appl. No.: 18/757,896

(22) Filed: Jun. 28, 2024

(51) Int. Cl. B60S 1/02; B60H 1/00

(52) U.S. Cl. CPC B60S 1/026; B60H 1/00064; B60H 1/00742; B60H 1/00785

(57) ABSTRACT

Methods and systems are disclosed herein for adaptive climate control based on thermal imaging, standard imaging, and/or physiological states of a user. A system instructs one or more thermal imaging cameras to capture thermal images and standard images of windows of a vehicle and determines, based on the thermal images and standard images, whether at least one of the windows is experiencing condensation conditions. Based on determining that one of the windows is experiencing the condensation conditions, the system identifies a climate control adjustment to ameliorate the condensation conditions of the window and causes a system of the vehicle to perform the climate control adjustment. Methods and systems are also disclosed for intelligent scheduling and temperature adjustment. After being informed of a user's scheduled bath time, a server proactively adjusts a water heater to ensure an ample hot water supply to fill a tub at a user's preferred temperature.

### BACKGROUND

The present disclosure is directed towards techniques for adaptive climate control based on thermal imaging, standard imaging, and/or physiological states of a user, e.g., tailoring cabin conditions of a vehicle throughout based at least in part on infrared thermal imaging and/or physiological states of its passengers.

### SUMMARY

Many vehicle systems rely on drivers to manage vehicle condensation conditions, such as fog and frost forming on the internal and external surface of windows, including front and rear windshields. Further, many vehicle climate systems use a one-size-fits-all approach to temperature and airflow regulation. Traditional systems often fail to recognize and adapt to the diverse and dynamic thermal comfort needs, and driving visibility needs, of individual passengers, leading to less-than-optimal comfort levels for occupants. This issue is particularly pronounced in vehicle environments with varying external temperatures, in which passengers may have different clothing insulation levels, and unique physiological responses to such vehicle environment.

In one approach, drivers and passengers are responsible for taking action to control their visibility and physiological comfort while within a vehicle. Drivers activate windshield wipers, defrosters, and de-foggers themselves, as well as set temperatures and intensities for the heating and air-conditioning systems and adjust vents within the car, based on their own subjective observations. However, this approach is deficient because the increased load on the driver to control their visibility conditions distracts from driving, and it is difficult to constantly adjust the each of the systems within a vehicle in a manner that is tailored to the individual comfort levels of each of the passengers.

In another approach, humidity sensors are used to detect condensation conditions. However, this approach is deficient because installing, maintaining, and replacing such humidity sensors is expensive. Moreover, detecting humidity alone may not enable comprehensively mapping out the presence of fog and frost on the internal and external surface of windows.

To overcome these problems, systems and methods are provided herein for techniques for adaptive climate control to tailor cabin conditions in a vehicle based at least in part on infrared thermal imaging and/or physiological states of passengers of a vehicle. In some embodiments, the system instructs one or more thermal imaging cameras to capture one or more thermal images of one or more windows of a vehicle and determines, based on the one or more thermal images, whether at least one of the windows is experiencing condensation conditions. Based on determining that one of the windows is experiencing the condensation conditions, the system identifies a climate control adjustment to ameliorate the condensation conditions of the window and causes a system of the vehicle to perform the climate control adjustment.

In some embodiments, the system of the vehicle performing the climate control adjustment is a heating, ventilation, and air-conditioning (HVAC) system. In some embodiments, the condensation condition is fog on the external surface of the windshield of the vehicle, and the climate control adjustment is the system causing activation of windshield wipers. In some embodiments, the condensation condition is frost on the external surface of a rear window of the vehicle, and the climate control adjustment is the system causing one or more of releasing anti-icing fluid, activating a rear window wiper, or activating heating strips built into the rear window for defogging and deicing. In some embodiments, the condensation condition is frost on the external surface of the windshield, and the climate control adjustment is the system causing one or more of activation of a windshield defroster, activation of a heating function of an air-conditioning portion of the HVAC system of the vehicle and direction of airflow towards portions of the windshield where frost is present or is likely to be present, releasing anti-icing fluid, or activation of windshield wipers. In some embodiments, the condensation condition is fog on an external surface of a window, and the climate control adjustment is the system causing the intermittent opening and closing of the side windows of the vehicle. In some embodiments, the condensation condition is fog on an internal surface of a window, and the climate control adjustment is the system causing activation of a heating function of an air-conditioning portion of the HVAC system of the vehicle and direction of airflow towards portions of the windows where internal fog is present. In some embodiments, the condensation condition is frost on the external surface of a window, and the climate control adjustment is the system causing activation of a heating function of an air-conditioning portion of the HVAC system of the vehicle and direction of airflow towards portions of the windows where frost is present.

Such aspects provide a more effective and efficient fog and frost detection management system, reducing the need for additional sensor installation and maintenance. This approach comprehensively addresses fog inside and outside windshields and vehicle windows, prioritizing areas pertinent to driver visibility and safety. Intelligent allocation of HVAC resources and proactive measures ensure optimal defogging and defrosting performance, enhancing safety and comfort for all vehicle occupants.

In some embodiments, the system detects the presence of current condensation conditions by capturing one or more standard images of the interior of the vehicle using a camera and using the standard images and the thermal images to detect the presence of current fog or frost on the windows. In some implementations, the system detects the presence of current condensation conditions from the thermal images and the standard images based on the shape of water droplets on the windows, how light interacts with the water droplets on the windows, or temperature differences across the windows of the vehicle. In some embodiments, the system employs a computer vision (CV) algorithm that analyzes images from the camera mounted inside the car. In some examples, this algorithm uses advanced image processing methods to identify whether fog or frost is on the interior or exterior of the glass. In some embodiments, the system employes locally run machine learning models to classify images and identify the objects in the images.

Such aspects enable immediate identification of conditions conductive to, and/or presence of, the formation of fog or frost on the interior or exterior parts of windows and effective distinguishing between internal and external fog or frost formations, allowing for targeted climate control actions to manage these conditions effectively.

In some embodiments, the system detects the likelihood of fog on the external surface of a window by using the thermal images to detect a temperature of the external surface of the window and determining that the temperature of the external surface of the window is lower than a dewpoint of an environment external to the vehicle by at least a threshold amount. In some implementations, the system detects the likelihood of fog on the internal surface of a window by using the one or more thermal images to detect a temperature of an external surface of the window, using the one or more thermal images to detect a temperature of an internal surface of the window, and determining the temperature of the internal surface of the window is cooler than the temperature of the external surface of the window by at least a threshold amount.

Such aspects allow thermal imaging to be effectively used as part of a system to anticipate and prevent fog formation on windows by monitoring temperature differences that lead to condensation. This approach can trigger preventive measures, such as activating defrosters or adjusting the heating and air-conditioning to maintain clear visibility, turning off air recirculating functions, automatically or periodically opening and closing windows to let moisture out, while also distinguishing between fog or frost and between its forming on the inside versus the outside of a vehicle's windows.

In some embodiments, the system captures at least one thermal image of the interior of the vehicle using the thermal imaging cameras, as well as one or more standard images of the interior of the vehicle using a camera. In some examples, the system then uses the thermal images and the standard images of the vehicle interior to generate an occupancy map identifying locations and body temperatures of passengers within the vehicle. In some implementations, the system then determines a difference between the current body temperature and the ideal body temperature for each passenger (based on user preferences and historical data). In some examples, the system uses the occupancy map and the differences between current and ideal body temperatures to determine passenger climate control adjustments to address the difference for each area of the occupancy map. The system then causes the system of the vehicle to perform the passenger climate control adjustments, e.g., directing or stopping flow of air through a controllable vent to an area of the occupancy map corresponding to a particular passenger or activating a heating coil of a heated seat occupied by the particular passenger.

In some embodiments, the system receives a current body temperature and an ideal body temperature of a potential passenger who is not yet in the vehicle. In some examples, the system determines, based on a current temperature within the vehicle, the current body temperature of the potential passenger, and the ideal body temperature of the potential passenger, a passenger climate control adjustment. The system then causes the system of the vehicle to perform the passenger climate control adjustment.

Such aspects introduce a more nuanced and responsive approach to managing cabin conditions. Leveraging advanced infrared thermal imaging technology allows for the detection of passengers' real-time thermal signatures, assessing not just the ambient cabin temperature but also the specific thermal state of each occupant. By integrating data on passengers' physiological states (such as detected stress levels, whether overheated or feeling too cold), the system can make informed adjustments to the cabin environment. This could involve directing airflow more precisely, adjusting the temperature in specific vehicle zones, and/or altering the humidity levels all to suit the occupants' needs. It offers a personalized climate experience that dynamically adjusts to the specific requirements of each passenger, ensuring optimal comfort for all occupants, regardless of the external climate conditions or individual preferences.

In some embodiments, ridesharing or robotaxi applications incorporate health considerations into their service protocols. For example, if a passenger's temperature, as recorded by a companion app or during the ride request, is elevated (potentially indicated a viral infection), the app could limit service options, such as denying certain ride requests or only allowing trips to healthcare facilities like clinics or hospitals. In some embodiments, ride-sharing apps differentiate services based on health data, allowing passengers with signs of illness to choose more private ride options, such as Uber Comfort, while restricting access to shared rides like Uber Share. Such aspects help minimize health risks to drivers and other passengers.

In some embodiments, robotaxis take further preventive actions based on a passenger's temperature reading. In some embodiments, when a passenger's temperature suggests they might be ill, subsequent measures include notifying the next passenger to disinfect their seat or temporarily removing the taxi from service for thorough cleaning and sanitization.

Such aspects enable intelligent vehicle systems, (e.g., HVAC systems), to adapt to personal comfort preferences and public health considerations. By integrating temperature preference settings via apps and considering health indicators like body temperature, vehicles offer tailored comfort settings while implementing safety protocols to protect passengers' well-being.

Another technological problem addressed by the present disclosure is that a common issue in homes with showers or tubs, such as, for example, whirlpool or jacuzzi tubs, is insufficient hot water supply from tank-style water heaters. When the water heater is set to a standard temperature, it may fail to provide enough hot water to fill these giant tubs to the desired temperature. Further, another common issue in homes is that users can usually only manipulate the HVAC systems within rooms when they are present in the home, so when a user arrives at home or in a certain room of their home after not being present for a period of time, the room may not be at their preferred temperature.

In one approach, users spend time waiting for the water to heat up to the desired temperature and accept that water supply will take more time to replenish. However, this approach is deficient because users often do not have ample amounts of time to wait for their water to heat, and they do not want to accept reduced water levels. In one approach, users can configure different settings for the HVAC system in their home based on whether the user is home or not, e.g., users can set the system to turn down the heat when the user is at work. However, this approach is deficient because it does not dynamically modify temperatures based on user's preferences and activities in each moment.

To overcome these problems, systems and methods are also provided herein for intelligent scheduling and temperature adjustment. After being informed of a user's scheduled bath time, a system proactively adjusts a water heater to ensure an ample hot water supply to fill a tub at a user's preferred temperature. This intelligent scheduling and temperature adjustment mechanism ensures that the user's experience is not compromised by the limitations of their water heating system.

In some embodiments, temperature sensors are installed within the tub, and in conjunction with the intelligent faucet, these sensors monitor the water temperature as the tub fills. In some examples, the system intelligently manages the filling process, incorporating pauses based on the current water temperatures from both the faucet and within the tub itself. In some embodiments, these pauses are strategically timed to allow the water heater to recover and supply hot water, preventing the tub temperature from dropping below the desired level. This method ensures a consistent and enjoyable bathing experience, maintaining the optimal water temperature.

In some embodiments, the system takes in inputs from users and/or smart equipment, interfaces with user and smart equipment to refine activity schedules and preferences, and schedules activities. In some embodiments, the system implements schedule-based temperature adjustments, and triggers adjustments for a smart AC control algorithm. In some examples, the system sets preferred temperatures for activities, leverages user-defined activity profiles to tailor environmental conditions, and defines preferences for the smart AC control algorithm.

In some embodiments, the smart AC control algorithm adjusts to optimal temperatures based on the preferences and employs smart scheduling to anticipate and respond to activity changes. In some examples, by integrating with a user's workout schedule or directly communicating with exercise equipment like a treadmill, the smart AC control algorithm can predict when to initiate temperature adjustments.

In some embodiments, through incorporating machine learning (ML) algorithms, the system can learn from user preferences and environmental conditions to further refine and personalize the water temperature and room temperature control process. In some examples, this ML integration allows for adaptive adjustments over time, catering more closely to the user's comfort preferences.

Such aspects improve management of water temperature and room temperature homes or other environments by combining personalized data, intelligent scheduling, and machine learning. This approach addresses the challenge of insufficient hot water supply and nonoptimal room temperatures and elevates the user's experience by ensuring personalized comfort through intelligent water temperature and room temperature control.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1 is an illustrative example of a system for adaptive climate control based on thermal imaging, standard imaging, and/or physiological states of a user, in accordance with some embodiments of the present disclosure;

FIG. 2A is an illustrative example of an integrated fog and frost detection and management system for vehicles, in accordance with some embodiments of the present disclosure;

FIG. 2B is an illustrative example of an autonomous fog and frost detection and management system for vehicle climate control, in accordance with some embodiments of the present disclosure;

FIG. 3 is an illustrative diagram of a personalized climate control system for enhanced comfort and safety in vehicles, in accordance with some embodiments of the present disclosure;

FIG. 4 is an illustrative example of a dynamic personalized temperature control system using wearable sensor technology, in accordance with some embodiments of the present disclosure;

FIG. 5 is an illustrative example of an intelligent water temperature control system for personalizing bathing experience, in accordance with some embodiments of the present disclosure;

FIG. 6 is an illustrative example of an intelligent climate control and health safety system for automated vehicles, in accordance with some embodiments of the present disclosure;

FIG. 7 is an illustrative example of an adaptive AC control system for personalized environmental comfort based on user activities, in accordance with some embodiments of the present disclosure;

FIG. 8 is a diagram of an illustrative media device, in accordance with some embodiments of this disclosure;

FIG. 9 is a diagram of an illustrative vehicle and device communication system, in accordance with some embodiments of this disclosure;

FIG. 10 is a flowchart of an illustrative process for adaptive climate control based on thermal imaging, in accordance with some embodiments of the present disclosure;

FIG. 11 is a flowchart of an illustrative process for adaptive climate control based on thermal imaging, in accordance with some embodiments of the present disclosure;

FIG. 12 is a flowchart of an illustrative process for illustrative process for adaptive climate control based on thermal imaging, in accordance with some embodiments of the present disclosure;

FIG. 13 is a flowchart of an illustrative process illustrative process for adaptive climate control based on thermal imaging, in accordance with some embodiments of the present disclosure;

FIG. 14 is a flowchart of an illustrative process for adaptive climate control based on thermal imaging, standard imaging, and/or physiological states of a user, in accordance with some embodiments of the present disclosure;

FIG. 15 shows illustrative examples of condensation conditions present on windows of a vehicle, in accordance with some embodiments of the present disclosure;

FIG. 16 shows illustrative examples of thermal images of the interior of vehicles and passengers for adaptive climate control, in accordance with some embodiments of the present disclosure.

### DETAILED DESCRIPTION OF EMBODIMENTS OF THE DISCLOSURE

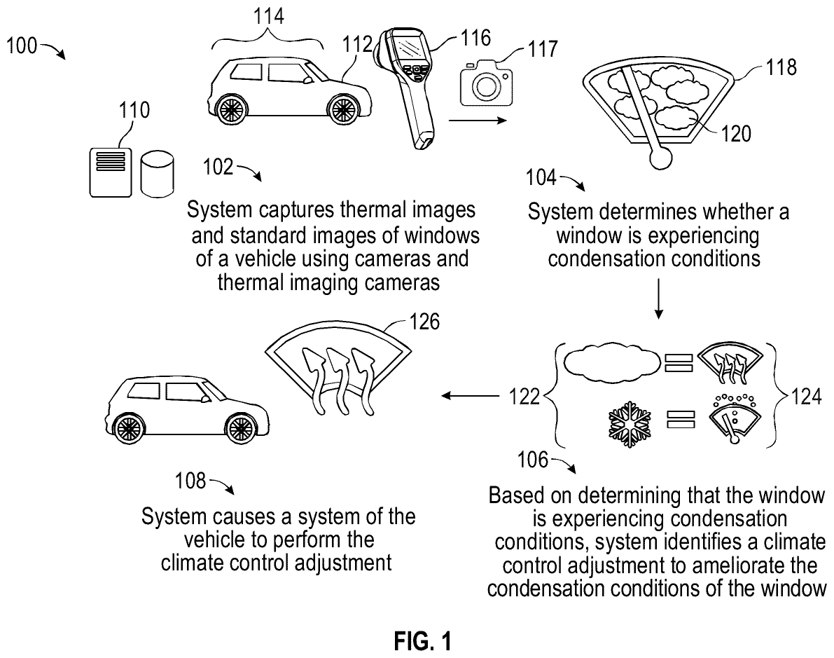

FIG. 1 is an illustrative example of a system for adaptive climate control based on thermal imaging, standard imaging, and/or physiological states of a user, in accordance with some embodiments of the present disclosure. In some embodiments, system 100 includes one or more servers 110, one or more vehicles 112, any suitable number of sensors, one or more databases, one or more mobile devices, one or more computing devices, or any other suitable device or component, or any suitable combination thereof. Vehicle 112 comprises one or more vehicle windows 114 including front windshield 118, a rear windshield, front side driver and passenger windows and back side passenger windows, a sunroof, rear view mirrors, and/or any other suitable windows. Vehicle 112 may comprise one or more thermal imaging cameras 116 and one or more cameras 117. System 100 may include additional servers, devices, and/or networks. For example, functionality of server 110 may be shared between several servers, providing a cloud computing solution. In some examples, the steps outlined within system 100 are performed by server 110, vehicle 112, and/or any other suitable devices, or any suitable combination thereof. In some embodiments, the system employs locally-run machine learning models (e.g., executed at least in part at vehicle 112) to classify images and identify the objects in the images, and/or remote machine learning models (e.g., executed at least in part at server 110). The actions and descriptions of FIG. 1 may be used with any other embodiment of this disclosure. In addition, the actions and descriptions described in relation to FIG. 1 may be done in suitable alternative orders or in parallel to further the purposes of this disclosure. Vehicle 112 may be a car (e.g., a coupe, a sedan, a truck, an SUV, a bus), a motorcycle, an aircraft (e.g., a drone), a watercraft (e.g., a boat), or any other type of vehicle. In some embodiments, vehicle 112 may be configured to operate autonomously or semi-autonomously.

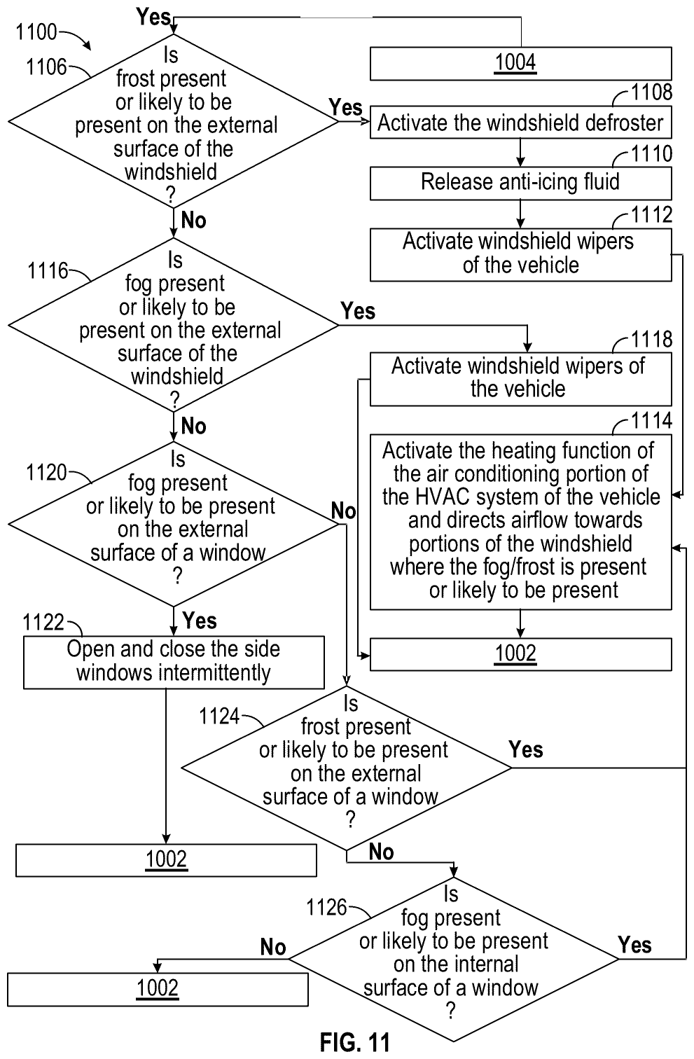

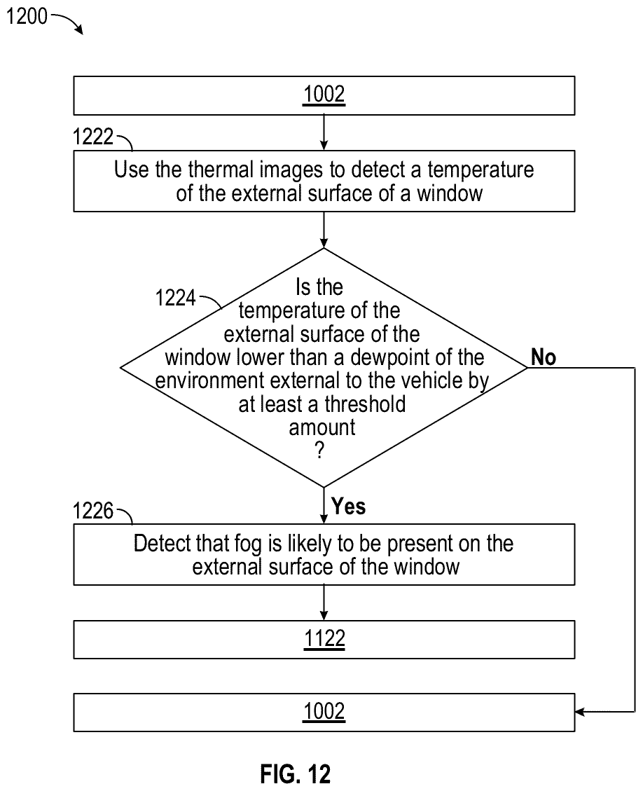

In some embodiments, at step 102, system 100 obtains thermal images of windows 114 of vehicle 112 using one or more thermal imaging cameras 116 and obtains standard images of windows 114 of vehicle 112 using one or more cameras 117. For example, server 110 may receive (e.g., over a network) thermal images of windows 114 of vehicle 112 which are captured using one or more thermal imaging cameras 116 of vehicle 113 and standard images of windows 114 of vehicle 112 which are captured using one or more cameras 117. At step 104, system 100 determines that windshield 118 of vehicle 112 is experiencing condensation conditions 120, such as, for example, fog on the internal surface of windshield 118. In some embodiments, system 100 determines that windshield 118 is experiencing condensation conditions 120 based on the thermal images and standard images, as described further below with reference to FIGS. 12, 13, and 15. At step 106, based on determining that windshield 118 is experiencing a condensation conditions of the list of condensation conditions 122, e.g., fog on the internal surface of the windshield and frost on the external surface of the windshield, system 100 identifies a climate control adjustment of the list of climate control adjustments, e.g., activating the heating function of the air-conditioning portion of the HVAC system of the vehicle and directing airflow towards the portions of the windshield where the fog is present for fog on the internal surface of the windshield and releasing anti-icing fluid for frost on the external surface of the windshield 124 to ameliorate the condensation conditions of windshield 118, as described further below with reference to FIG. 11. At step 108, system 100 causes a system of vehicle 112, for example, an HVAC system, to perform climate control adjustment 126, as described further below with reference to FIG. 11. For example, system 100 may perform the climate control adjustment of turning on the heating function of the HVAC system and directing airflow towards the affected area, based on determining that condensation conditions 122 is present.

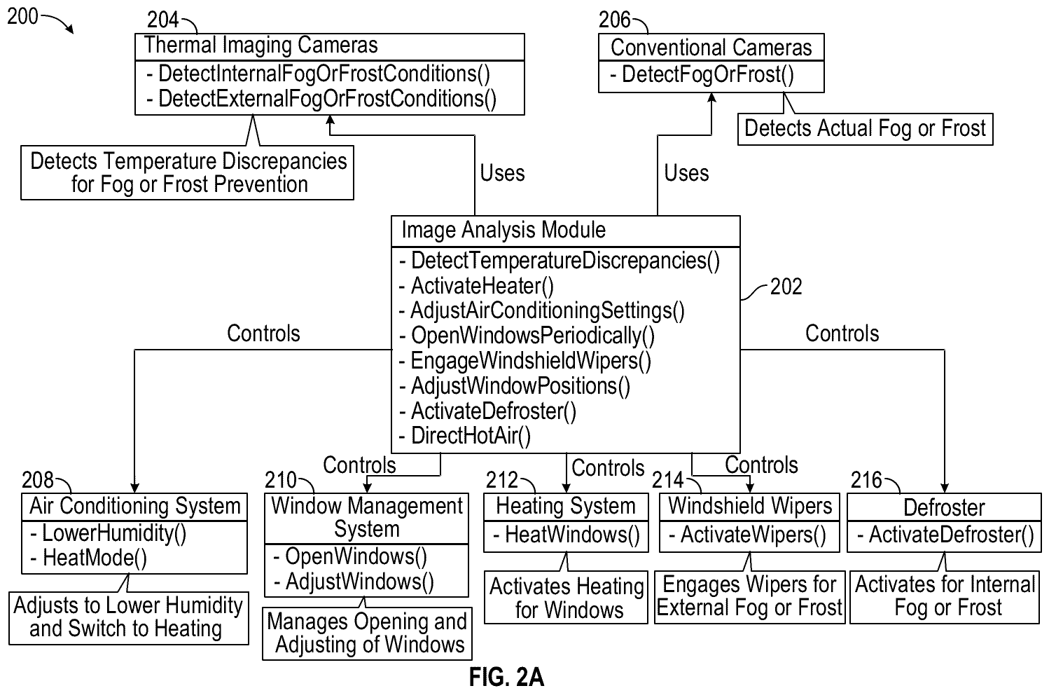

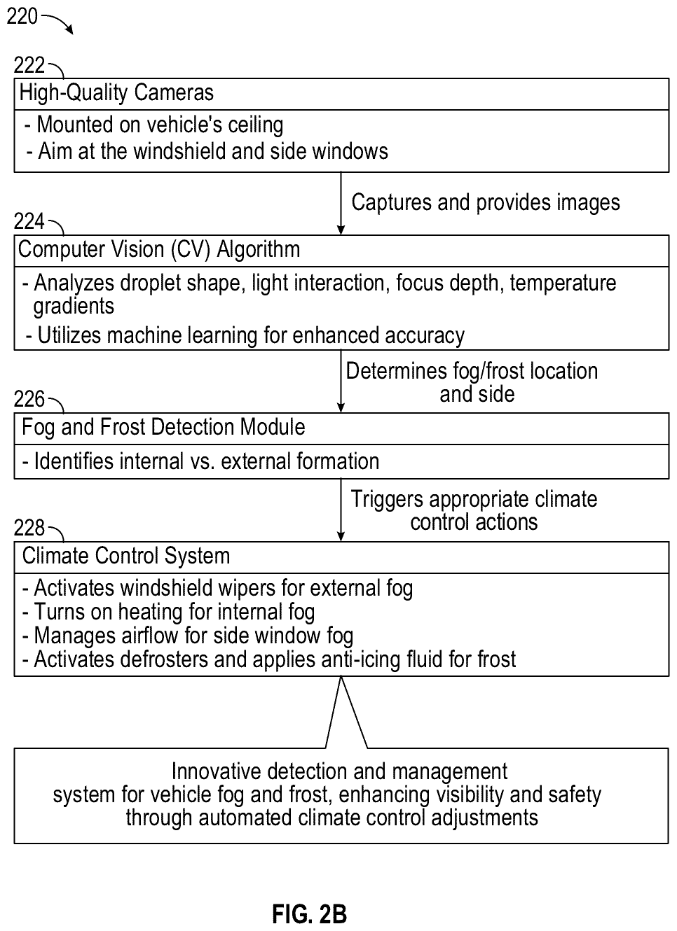

FIG. 2A is an illustrative example of an integrated fog and frost detection and management system for vehicles, in accordance with some embodiments of the present disclosure. In some embodiments, system 200 (which may correspond to system 100 of FIG. 1) includes image analysis module 202, thermal imaging cameras 204, conventional cameras 206, air-conditioning system 208, windows management system 210, heating system 212, windshield wipers 214, and defroster 216.

In some embodiments, thermal imaging cameras 204 corresponds to the one or more thermal imaging cameras 116 of FIG. 1. In some examples, thermal imaging cameras 204 and conventional cameras 206 are affixed to the ceiling of a vehicle, e.g., vehicle 112 of FIG. 1, or at any other suitable portion of the interior or exterior of the vehicle, and are aimed at pertinent viewing areas (e.g., the windshield and/or side windows) to employ advanced image processing to achieve accurate detection. In some implementations, image analysis module 202 utilizes thermal imaging cameras 204 and conventional cameras 206 to accurately identify the location and side (interior or exterior) of glass surfaces where condensation conditions, e.g., fog or frost, has formed by detecting patterns of moisture droplets or frost.

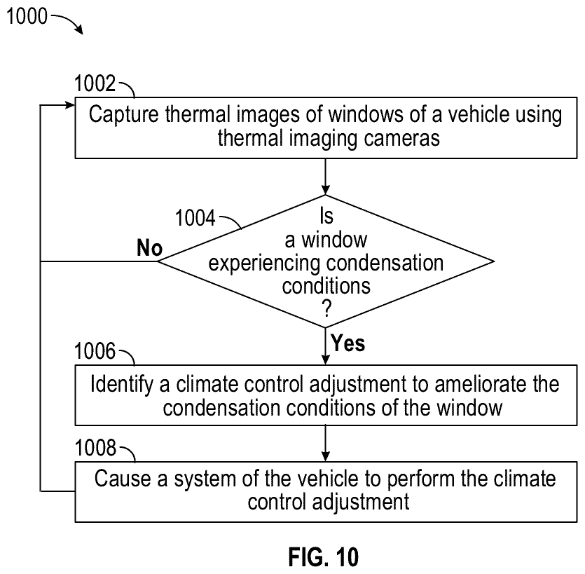

In some embodiments, image analysis module 202 detects temperature discrepancies, and based at least in part on such discrepancies and/or the detected condensation conditions and/or other suitable factors, activates a vehicle heater, adjusts air-conditioning settings of the vehicle, opens and closes vehicle windows periodically, automatically (e.g., without explicit user input) engages windshield wipers of the vehicle and/or heated mirrors, adjusts window positions of the vehicle, activates the defroster of the vehicle, directs hot air within the vehicle, and/or performs any other suitable function. In some examples, image analysis module 202 uses thermal imaging cameras 204 to detect internal and external fog or frost conditions. In some embodiments, thermal imaging cameras 204 detect temperature discrepancies for fog or frost prevention, as described further below in reference to FIGS. 10, 11, 12, and 13. In some embodiments, image analysis module 202 uses conventional cameras 206 to detect fog or frost, as described further below with reference to FIGS. 10 and 11.

In some embodiments, image analysis module 202 provide instructions or control signals to air-conditioning system 208, based at least in part on whether a condensation condition is identified by image analysis module 202. In some examples, air-conditioning system 208 can switch to a heating mode to heat the vehicle and lower the humidity of the vehicle. In some embodiments, image analysis module 202 controls windows management system 210. In some examples, windows management system 210 manages the opening and adjusting of windows in the vehicle. In some embodiments, image analysis module 202 provide instructions or control signals to heating system 212. In some examples, heating system 212 activates heating for the windows of the vehicles. In some embodiments, image analysis module 202 controls windshield wipers 214. In some examples, windshield wipers 214 are activated to address fog and frost conditions on an external surface of one or more windows of the vehicle. In some embodiments, image analysis module 202 controls defroster 216. In some examples, defroster 216 is activated to address fog or frost on an internal surface of one or more windows of the vehicle (e.g., within the vehicle cabin).

FIG. 2B is an illustrative example of an autonomous fog and frost detection and management system (which may be included in system 200) for vehicle climate control, in accordance with some embodiments of the present disclosure. In some embodiments, system 220 includes high-quality cameras 222, computer vision (CV) algorithm 224, fog and frost detection module 226, and climate control system 228. In some embodiments, high-quality cameras include thermal imaging cameras 204 and conventional cameras 206 of FIG. 2A. In some implementations, high-quality cameras 222 are mounted on a vehicle's ceiling (e.g., vehicle 112 of FIG. 1), or any other suitable portion of the interior or exterior of the vehicle and aimed at the windshield and side windows to capture and provide images for use by CV algorithm 224. In some embodiments, CV algorithm 224 identifies whether fog or frost has formed inside or outside a vehicle's windows (e.g., windows 114 of vehicle 112 of FIG. 1) based on images from high-quality cameras 222 by examining various indicators such as the shape of droplets, how light interacts with them, the depth of field in the images, temperature differences across the glass of the window (e.g., indicated in thermal imagery), and/or based on any other suitable indicators. CV algorithm 224 can utilize machine learning techniques to analyze images from the high-quality cameras 222 to determine where fog or frost is formed and on which side of a window (e.g., the external surface of a window in the environment external to the vehicle, or the internal surface of the window in the environment facing the vehicle's cabin), enabling the precise detection and differentiation between internal and external fog or frost and ensuring appropriate measures are taken to maintain clear visibility. In some examples, by integrating focused image analysis and control strategies, CV algorithm 224 enables the vehicle to manage fog and frost autonomously and precisely. In some implementations, CV algorithm 224 determines the exact position and size of one or more portions of the affected glass and initiates specific countermeasures tailored to the nature and location of the visibility obstruction.

In some embodiments, based on the analysis of CV algorithm 224 to determine the fog or frost location and side, fog and frost detection module 226 identifies internal versus external fog formation, as described further below with reference to FIGS. 10, 11, 12, and 13. In some examples, fog and frost detection module 226 then triggers appropriate climate control actions from climate control system 228. In some embodiments, climate control system 228 activates windshield wipers for external fog, turns on heating for internal fog, manages airflow for side window fog, activates defrosters and applies anti-icing fluid for frost, and executes any other climate control adjustment necessary, as described further below with reference to FIG. 11, to ameliorate condensation conditions. In some embodiments, climate control system 228 is an innovative detection and management system for vehicle fog and frost, enhancing visibility and safety through automated climate control adjustments.

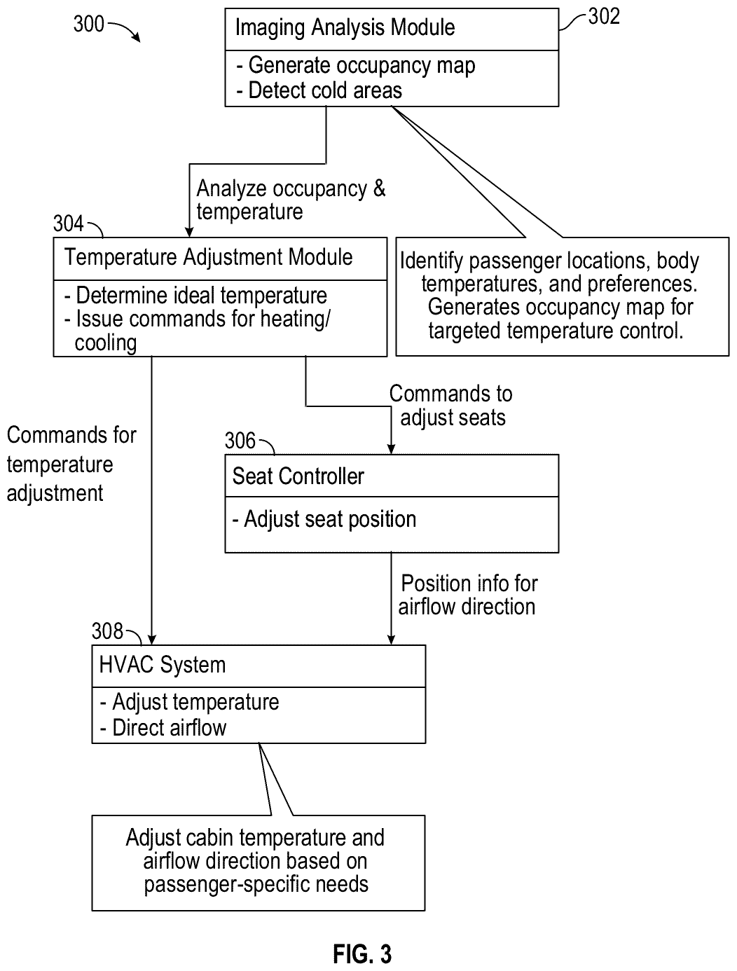

FIG. 3 is an illustrative diagram of a personalized climate control system for enhanced comfort and safety in vehicles, in accordance with some embodiments of the present disclosure. In some embodiments, system 300 (which may correspond or be included in system 100 and/or 200) includes imaging analysis module 302 (which may correspond to image analysis module 202 of FIG. 2), temperature adjustment module 304, seat controller 306, and HVAC system 308. In some examples, imaging analysis module 302 uses cameras, e.g., high-quality cameras 222 of FIG. 2B, to identify passenger locations, body temperatures, and preferences; generate an occupancy map for targeted climate control; and detect cold areas of the occupancy map. In some embodiments, the occupancy map is a data structure that stores a count of the number of passengers within a vehicle (e.g., vehicle 112 of FIG. 1), pinpoints their exact location (such as front or back, passenger or driver side, second row, third row, etc.) and measures their body temperatures. In some embodiments, the temperature adjustment module 304 prioritizes comfort for a seat with a car seat holding an infant. In some embodiments, for enhanced precision, imaging analysis module 302 gathers metadata concerning each passenger's seat position (inclined or declined) and their proximity to the nearest air vent, information sourced directly from seat controller 306, and/or any other suitable data. In some embodiments, temperature adjustment module 304 is tasked with determining the ideal temperature for each passenger and issuing commands for heating and cooling. In some embodiments, the ideal temperature determination is influenced by individual user preferences and historical data, which can be tied to specific seats within the vehicle or collected through external devices like mobile phones or smartwatches. In some embodiments, utilizing this comprehensive data, temperature adjustment module 304 sends commands to adjust seats to seat controller 306 and sends commands for temperature adjustment to HVAC system 308. In some examples, seat controller 306 adjusts the position of seats and sends position information for airflow direction to HVAC system 308. In some implementations, HVAC system 308 intelligently identifies which seats or vehicle zones need temperature adjustments and adjusts cabin temperature and airflow direction based on passenger-specific needs. For instance, HVAC system 308 recognizes that seat number three requires heating and employs an integrated heating coil in such seat, and/or directs airflow towards such seat using a particular vent, for optimal temperature control. In this example, by comparing a current body temperature of a passenger with their preferred temperature setting, HVAC system 308 calculates the necessary adjustments (e.g., venting or heating) to achieve comfort. In some instances, these adjustments may also include modifying the seat's position or the directions of the vents to attain the target temperature quickly. For example, upon detecting that a passenger's feet are colder than desired, HVAC system 308 may issue specific commands to direct warm air toward the lower part of the seat, ensuring the passenger's feet are warmed efficiently.

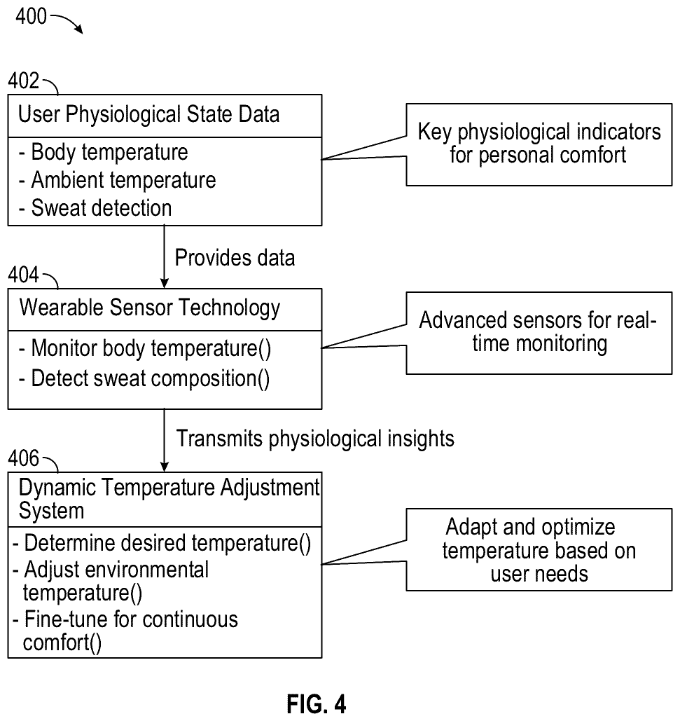

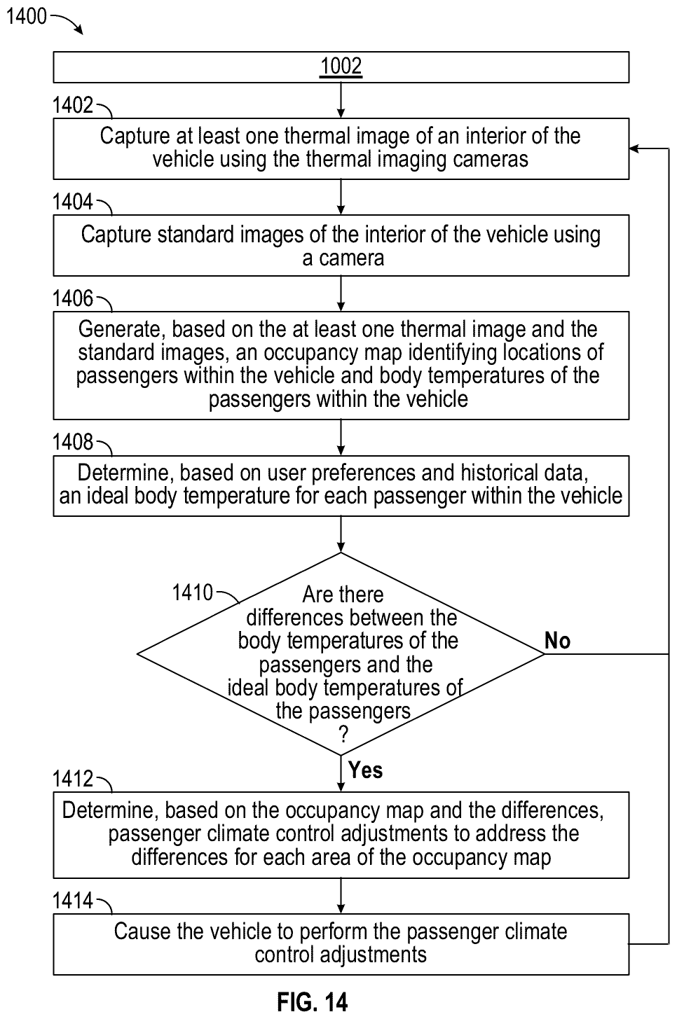

FIG. 4 is an illustrative example of a dynamic personalized temperature control system using wearable sensor technology, in accordance with some embodiments of the present disclosure. In some embodiments, system 400 includes user physiological state data 402, wearable sensor technology 404, and dynamic temperature adjustment system 406. In some examples, dynamic temperature adjustment system 406 integrates user physiological state data 402, such as body temperature, ambient temperature and sweat detection (key physiological indicators for personal comfort) captured by wearable sensor technology 404. In some embodiments, user physiological state data 402 involves an initial determination of the user's preferred temperature made by analyzing a combination of factors: the user's current body temperature, the ambient temperature of the surrounding environment, and/or the detection of sweat, which serves as an indicator of discomfort due to excessive heat or activity. In some embodiments, user physiological state data 402 is collected based on images from thermal imaging cameras, e.g., thermal imaging cameras 116 of FIG. 1, as described further below with reference to FIG. 14. In some embodiments, once these parameters are established, dynamic temperature adjustment system 406 dynamically adjusts the temperature to align with the user's comfort level. In some embodiments, this adjustment is not a one-time action but a continuous process that adapts as the user acclimates to the changing environment. In some examples, dynamic temperature adjustment system 406 monitors the user's physiological responses and makes incremental adjustments to ensure the temperature remains at the optimal level of comfort. In some embodiments, dynamic temperature adjustment system 406 fine-tunes the settings, ensuring sustained comfort over time. In some embodiments, wearable sensor technology 404 comprises sensors capable of analyzing the molecular composition of sweat. In some embodiments, this analysis provides insights into the user's comfort levels, allowing for precise temperature adjustments based on real-time physiological data.

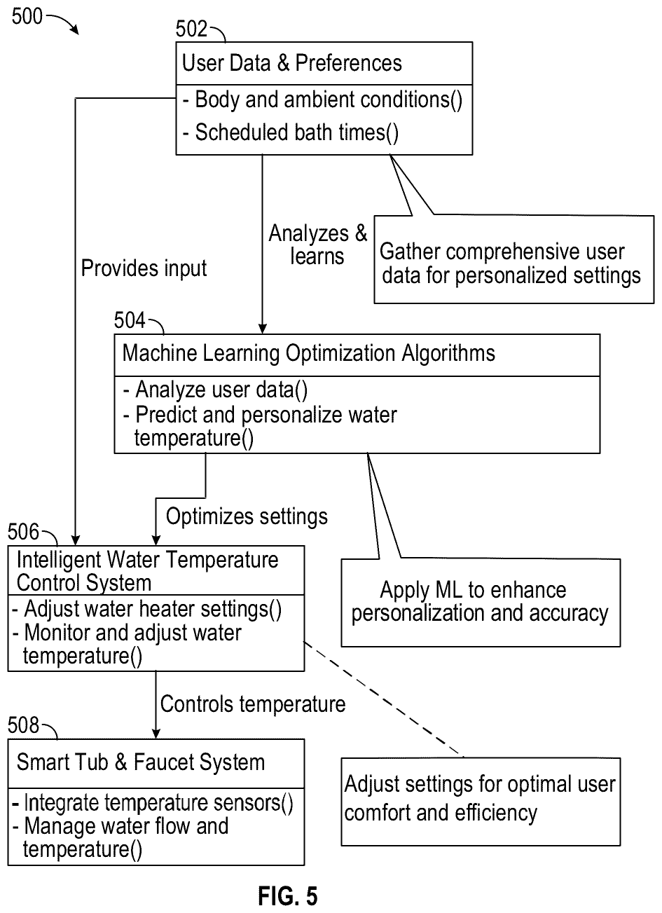

FIG. 5 is an illustrative example of an intelligent water temperature control system for personalizing a bathing experience, in accordance with some embodiments of the present disclosure. In some embodiments, system 500 includes user data and preferences 502, machine learning optimization algorithms 504, intelligent water temperature control system 506, and smart tub and faucet system 508.

In some embodiments, user data and preferences 502 are gathered comprehensive data for personalized settings, including body and ambient conditions and scheduled bath times of users. In some embodiments, user data and preferences 502 are provided to machine learning optimization algorithms 504 for analysis and learning. In some examples, user data and preferences 502 are provided as input to intelligent water temperature control system 506.

In some embodiments, machine learning optimization algorithms 504 analyze user data and apply machine learning to predict and personalize water temperature with enhanced personalization and accuracy. In some examples, machine learning optimization algorithms 504 help to optimize settings for intelligent water temperature control system 506. In some embodiments, intelligent water temperature control system 506 leverages any suitable number of inputs, e.g., historical or current sweat levels of a user, historical or current body temperatures of a user, the ambient temperature of the user's recent environment, and ambient humidity, to adjust water heater settings for optimal user comfort and efficiency and monitors and adjusts the water temperature at faucets precisely. In some embodiments, intelligent water temperature control system 506 controls the temperature of smart tub and faucet system 508. In some embodiments, smart tub and faucet system 508 integrates temperature sensors and manages water flow and temperature.

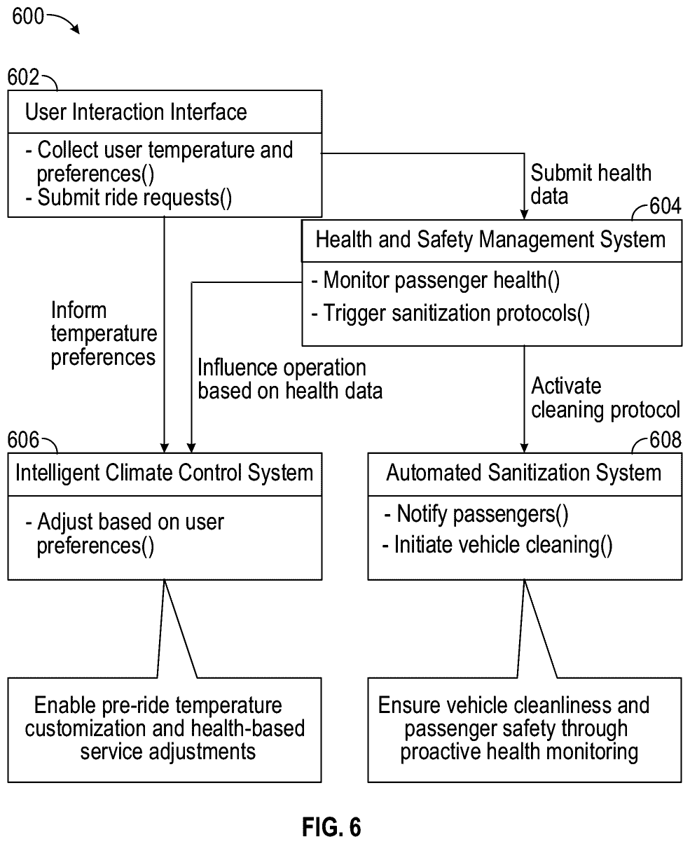

FIG. 6 is an illustrative example of an intelligent climate control and health safety system for automated (e.g., autonomous or semi-autonomous) vehicles, in accordance with some embodiments of the present disclosure. In some embodiments, system 600 includes user interaction interface 602, health and safety management system 604, intelligent climate control system 606, and automated sanitization system 608. In some embodiments, system 600 may be used in connection with one or more ride sharing applications.

In some embodiments, user interaction interface 602 collects the temperature and preferences of each user, allows users to submit ride requests, submits health data to health and safety management system 604, and informs intelligent climate control system 606 of temperature preferences of users. In some examples, health and safety management system 604 monitors passenger health, triggers sanitization protocols, influences the operations of intelligent climate control system 606 based on health data, and activates cleaning protocols of automated sanitization system 608.

In some embodiments, intelligent climate control system 606 adjusts the climate of the vehicle, e.g., vehicle 112 of FIG. 1, based on user preferences and enables pre-ride temperature customization and health-based service adjustments. In some examples, intelligent climate control system 606 can be controlled remotely, enhancing passenger comfort by pre-adjusting the cabin temperature according to personal preferences. For example, users can specify their desired temperature setting through an app when ordering a robotaxi. In this example, upon receiving this preference, intelligent climate control system 606 assesses the current cabin temperature and estimated time to the passenger's destination and strategically decides the optimal moment to begin temperature adjustments. In some embodiments, factors such as the specifications of intelligent climate control system 606 and the external temperature help determine the adjustment duration to achieve the requested change, for example, cooling the car by 3 degrees from 76° F. to 73° F. In some embodiments, automated sanitization system 608 ensures vehicle cleanliness and passenger safety through proactive health monitoring. In some examples, automated sanitization system 608 notifies passengers of a sanitization issue, and initiates vehicle cleaning. For example, a passenger that is potentially sick is able to order Uber Comfort but not Uber Share, where other passengers might be present. In some embodiments, robotaxis use the passenger's temperature to take remedy actions, for example, inform the next passenger to wipe the seat or put the taxi out of service until proper sanitization takes place.

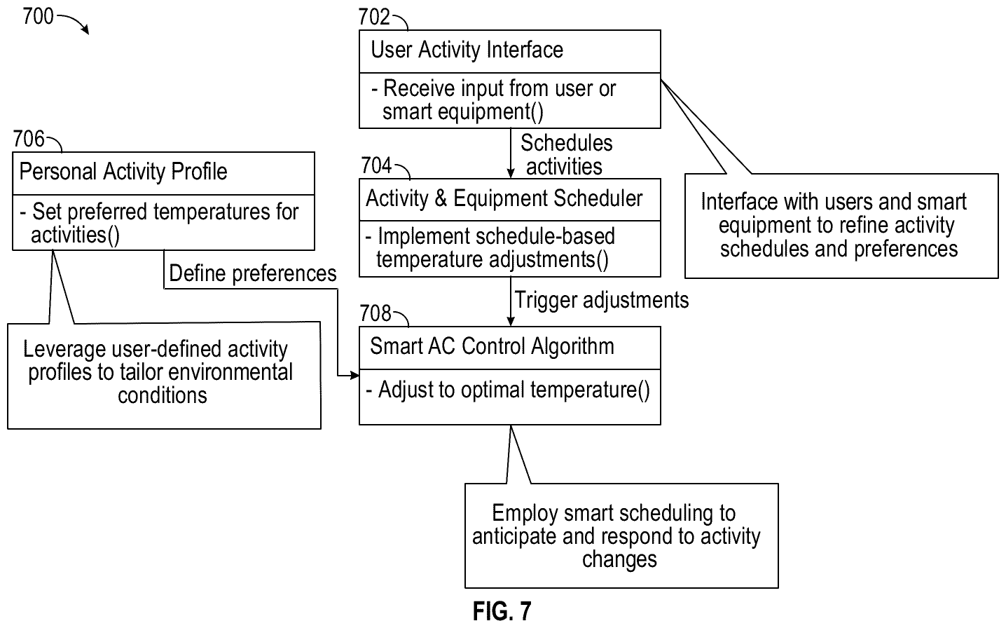

FIG. 7 is an illustrative example of an adaptive AC control system for personalized environmental comfort based on user activities, in accordance with some embodiments of the present disclosure. In some embodiments, system 700 includes user activity interface 702, activity and equipment scheduler 704, personal activity profile 706, and smart AC control algorithm 708.

In some embodiments, user activity interface 702 takes in inputs from users and/or smart equipment, interfaces with user and smart equipment to refine activity schedules and preferences, and schedules activities for activity and equipment scheduler 704. In some implementations, activity and equipment scheduler 704 implements schedule-based temperature adjustments and triggers adjustments for smart AC control algorithm 708. In some examples, personal activity profile 706 sets preferred temperatures for activities, leverages user-defined activity profiles to tailor environmental conditions, and defines preferences for smart AC control algorithm 708.

In some embodiments, smart AC control algorithm 708 adjusts to optimal temperatures based on the preferences and employs smart scheduling to anticipate and respond to activity changes. In some examples, smart AC control algorithm 708 caters to the user's temperature preferences, especially during specific activities. For example, a user might specify a preference for the room temperature to be approximately 68° F. while using a treadmill but opt for a more relaxing environment of around 72° F. post-exercise. In some embodiments, the adaptability of smart AC control algorithm 708 extends to anticipating and responding to changes in activity. In some examples, by integrating with a user's workout schedule or directly communicating with exercise equipment like a treadmill, smart AC control algorithm 708 can predict when to initiate temperature adjustments. For example, when a treadmill communicates that a user has begun a one-hour workout, smart AC control algorithm 708 strategically plans the temperature adjustment to ensure the environment reaches 72° F. towards the end of their workout.

In some embodiments, users can specify their preferred temperatures for different activities, enhancing comfort and satisfaction. In some examples, smart AC control algorithm 708 adjusts the temperature in anticipation of changes in user activity, such as during and after a workout, based on schedules or direct signals from exercise equipment.

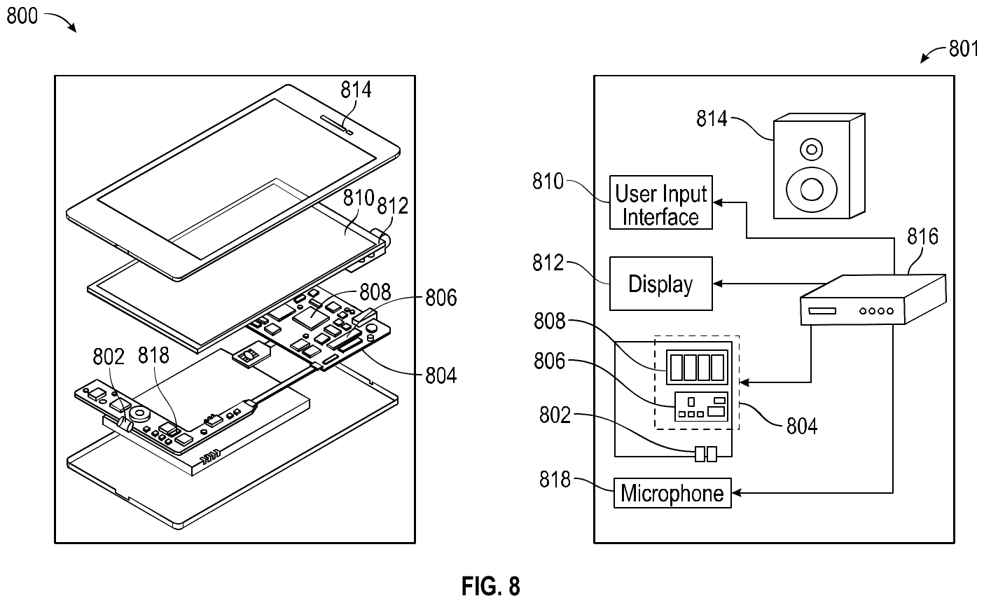

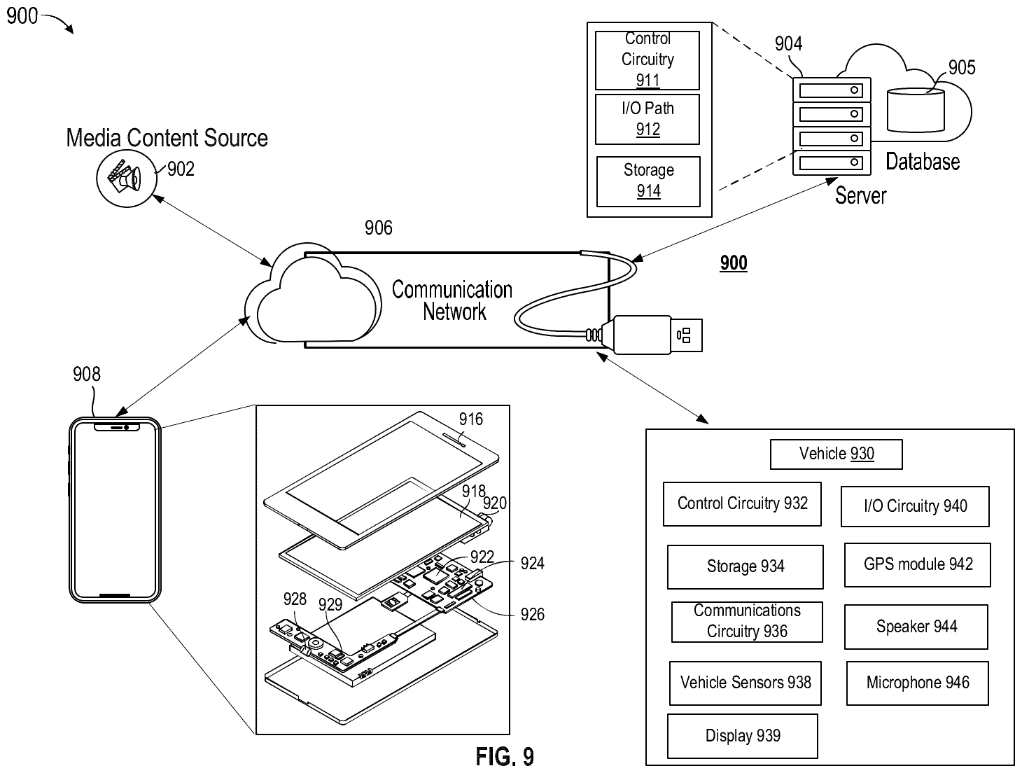

FIGS. 8 and 9 describe exemplary devices, systems, servers, and related hardware for adaptive climate control based on thermal imaging, standard imaging, and/or physiological states of a user, in accordance with some embodiments of the present disclosure. FIG. 8 shows generalized embodiments of illustrative devices 800 and 801. For example, devices 800 and 801 may be smartphone devices, laptops, televisions, smart televisions, streaming sticks, smart speakers, or voice assistants. Device 801 may include set-top box 816. Set-top box 816 may be communicatively connected to microphone 818, speaker 814, and display 812. In some embodiments, microphone 818 may receive voice commands. In some embodiments, display 812 may be a television display or a computer display. In some embodiments, set-top box 816 may be communicatively connected to user input interface 810. In some embodiments, user input interface 810 may be a remote-control device. Set-top box 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive content and data via input/output (“I/O”) path 802. I/O path 802 may provide content (e.g., broadcast programming, on-demand programming, internet content, content available over a local area network (LAN) or wide area network (WAN), and/or other content) and data to control circuitry 804, which includes processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a media application stored in memory (i.e., storage 808). Specifically, control circuitry 804 may be instructed by the media application to perform the functions discussed above and below. In some implementations, any action performed by control circuitry 804 may be based on instructions received from the media application.

In client/server-based embodiments, control circuitry 804 may include communications circuitry suitable for communicating with a media application server or other networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry, such as one or more analog tuners, one or more MPEG-4 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The tuning and encoding circuitry may be used by device 800, 801 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from device 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of device 800 and device 601. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The media application may be implemented using any suitable architecture. For example, it may be a stand-alone application wholly implemented on each one of device 800 and device 801. In such an approach, instructions of the application are stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to perform climate control adjustments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the media application is a client/server-based application. Data for use by a thick or thin client implemented on each one of device 800 and device 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the application in a storage device. The remote server may process the stored instructions using circuitry (e.g., control circuitry 804) to perform the operations discussed in connection with FIGS. 1-7 and 10-16.

In some embodiments, the media application may be downloaded and interpreted or otherwise run by an interpreter or virtual machine (run by control circuitry 804). In some embodiments, the media application may be encoded in the ETV Binary Interchange Format (EBIF), received by the control circuitry 804 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804. In some of such embodiments (e.g., those employing MPEG-2 or other digital media encoding schemes), the media application may be, for example, encoded and transmitted in an MPEG-2 object carousel with the MPEG audio and video packets of a program.

FIG. 9 is a diagram of an illustrative system 900 for diagram of an illustrative vehicle and device communication system, in accordance with some embodiments of this disclosure. User equipment device 908 (e.g., which may correspond to a mobile device of an occupant or operator of vehicle 112 of FIG. 1) may be coupled to communication network 906.

Communication network 906 may be one or more networks including the Internet, a mobile phone network, mobile voice or data network (e.g., a 5G, 4G, or LTE network), cable network, public switched telephone network, short-range communication network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing. Any suitable number of additional user equipment devices may be employed (e.g., a user device of an occupant or operator of vehicle 112).

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 906.

System 900 may comprise media content source 902 and server 904. In some embodiments, media content source 902 may correspond to server 904 and/or media content source 902 may correspond to server 904 may be under the control of or otherwise associated with a media content provider. In addition, there may be more than one of each of media content source 902 and server 904, but only one of each is shown in FIG. 5 to avoid overcomplicating the drawing. If desired, media content source 902 and server 904 may be integrated as one source device. In some embodiments, the adaptive climate control application may be executed at one or more of control circuitry 911 of server 904 and control circuitry 932 of vehicle 930 (and/or control circuitry of user equipment device 908).

In some embodiments, server 904 may include control circuitry 911 and storage 914 (e.g., RAM, ROM, Hard Disk, Removable Disk, etc.). Storage 914 may store one or more databases 905. Server 904 may also include an input/output path 912. I/O path 912 may provide device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 (and specifically processing circuitry thereof) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 911 executes instructions for an emulation system application stored in memory (e.g., the storage 914). Memory may be an electronic storage device provided as storage 914 that may be part of control circuitry 911.

In some embodiments, server 904 may retrieve guidance data from media content source 902, process the data as will be described in detail below, and forward the data to user equipment device 908 and/or vehicle 930. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an Internet provider of content of broadcast programs for downloading, etc.). Media content source 902 may include cable sources, satellite providers, on-demand providers, Internet providers, over-the-top content providers, or other providers of content. Media content source 902 may also include a remote media server used to store different types of content (including audio and/or video and/or audiovisual content selected by a user), in a location remote from any of the client devices. Media content source 902 may also provide supplemental content relevant to the metadata of a particular scene of a media asset as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the Internet via communication network 906. In such embodiments, user equipment devices may operate in a peer-to-peer manner without communicating with a central server.

User equipment device 908 may be a smartphone device or a user television equipment system or device. In some embodiments, microphone 929 may receive voice commands for the adaptive climate control application. In some embodiments, display 920 may be a television display or a computer display. In some embodiments, user input interface 918 may be a remote-control device. In some embodiments, the circuit boards may include control circuitry, processing circuitry, and storage (e.g., RAM, ROM, hard disk, removable disk, etc.). In some embodiments, the circuit boards may include an input/output path. User equipment device 908 may receive content and data via input/output (I/O) path 928. I/O path 928 may provide content (e.g., broadcast programming, on-demand programming, Internet content, content available over a local area network (LAN) or wide area network (WAN), and/or other content) and data to control circuitry 926, which may comprise processing circuitry 924 and storage 922. Control circuitry 926 may be used to send and receive commands, requests, and other suitable data using I/O path 928, which may comprise I/O circuitry. I/O path 928 may connect control circuitry 926 (and specifically processing circuitry 924) to one or more communications paths (described below). I/O functions may be provided by one or more of these communications paths but are shown as a single path in FIG. 5 to avoid overcomplicating the drawing.

Control circuitry 926 may be based on any suitable control circuitry such as processing circuitry 924. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 926 executes instructions for the adaptive climate control application stored in memory (e.g., storage 922). Specifically, control circuitry 926 (and/or control circuitry 932 of vehicle 930) may be instructed by the adaptive climate control application to perform the functions discussed above and below. In some implementations, processing or actions performed by control circuitry 926 may be based on instructions received from the adaptive climate control application.

In client/server-based embodiments, control circuitry 926 may include communications circuitry suitable for communicating with an adaptive climate control application server or other networks or servers. The instructions for carrying out the above-mentioned functionality may be stored on a server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 922 that is part of control circuitry 926. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 922 may be used to store various types of content described herein as well as adaptive climate control application described above. Nonvolatile memory may also be used (e.g., to launch a boot-up routine and other instructions). Cloud-based storage, described in relation to FIG. 5, may be used to supplement storage 922 or instead of storage 922.

Control circuitry 926 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 926 may also include scaler circuitry for upconverting and downconverting content into the preferred output format of user equipment device 908. Control circuitry 926 may also include digital-to-analog converter circuitry and analog-to-digital converter circuitry for converting between digital and analog signals. The tuning and encoding circuitry may be used by user equipment device 908 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 922 is provided as a separate device from user equipment device 908, the tuning and encoding circuitry (including multiple tuners) may be associated with storage 922.

Control circuitry 926 may receive instruction from a user by way of user input interface 918. User input interface 918 may be any suitable user interface, such as a remote control, mouse, trackball, keypad, keyboard, touch screen, touchpad, stylus input, joystick, voice recognition interface, or other user input interfaces. Display 920 may be provided as a stand-alone device or integrated with other elements of each one of user equipment device 908. For example, display 920 may be a touchscreen or touch-sensitive display. In such circumstances, user input interface 918 may be integrated with or combined with display 920. Display 920 may be one or more of a monitor, a television, a display for a mobile device, or any other type of display. A video card or graphics card may generate the output to display 920. The video card may be any control circuitry described above in relation to control circuitry 926. The video card may be integrated with control circuitry 926. Speakers 916 may be provided as integrated with other elements of each one of user equipment device 908 or may be stand-alone units. The audio component of videos and other content displayed on display 920 may be played through the speakers 916. In some embodiments, the audio may be distributed to a receiver (not shown), which processes and outputs the audio via speakers 916.

The adaptive climate control application may be implemented using any suitable architecture. For example, it may be a stand-alone application wholly implemented on vehicle 930 and/or user equipment device 908. In such an approach, instructions of the application are stored locally (e.g., in storage 922), and data for use by the application is downloaded on a periodic basis (e.g., from an out-of-band feed, from an Internet resource, or using another suitable approach). Control circuitry 926 may retrieve instructions of the application from storage 922 and process the instructions to provide climate control adjustments as discussed.

Based on the processed instructions, control circuitry 926 may determine what action to perform when input is received from user input interface 918. For example, movement of a cursor on a display up/down may be indicated by the processed instructions when user input interface 918 indicates that an up/down button was selected.

In some embodiments, the adaptive climate control application is a client/server-based application. Data for use by a thick or thin client implemented on each one of user equipment device 908 is retrieved on-demand by issuing requests to a server remote to each one of user equipment device 908. In one example of a client/server-based guidance application, control circuitry 926 runs a web browser that interprets web pages provided by a remote server. For example, the remote server may store the instructions for the application in a storage device. The remote server may process the stored instructions using circuitry (e.g., control circuitry 911) to perform the operations discussed in connection with FIGS. 1-7 and 10-16.

In some embodiments, the adaptive climate control application may be downloaded and interpreted or otherwise run by an interpreter or virtual machine (e.g., run by control circuitry 932 and/or run by control circuitry 926). In some embodiments, the adaptive climate control application may be encoded in the ETV Binary Interchange Format (EBIF), received by control circuitry 932 and/or run by control circuitry 926 as part of a suitable feed, and interpreted by a user agent running on control circuitry 926. For example, the wireless vehicle security application may be an EBIF application. In some embodiments, the adaptive climate control application may be defined by a series of JAVA-based files that are received and run by a local virtual machine or other suitable middleware executed by control circuitry 932 and/or run by control circuitry 926. In some of such embodiments (e.g., those employing MPEG-2 or other digital media encoding schemes), the adaptive climate control application may be, for example, encoded and transmitted in an MPEG-2 object carousel with the MPEG audio and video packets of a program.

System 900 may comprise one or more vehicles 930 (which may correspond to vehicle 112 of FIG. 1). Vehicle 930 may comprise control circuitry 932, storage 934, communications circuitry 936, vehicle sensors 938, display 939, I/O circuitry 940, GPS module 942, speaker 944, and microphone 946. In some embodiments, control circuitry 932, storage 934, communications circuitry 936, display 939, I/O circuitry 940, speaker 944, and microphone 946 may be implemented in a similar manner as discussed in connection with corresponding components of server 904 and/or user equipment device 908. In some embodiments, communications circuitry 936 may be suitable for communicating with an adaptive climate control application server or other networks or servers or external devices (e.g., via one or more antennas provided on an exterior or interior of vehicle 930) In some embodiments, communications circuitry 936 may be included as part of control circuitry 932.

In some embodiments, GPS module 942 may be in communication with one or more satellites or remote servers to enable vehicle 930 to provide upcoming directions, e.g., recited via speaker 944 and/or provided via display 939, to aid in vehicle navigation. In some embodiments, vehicle 930 is an autonomous vehicle capable of automatically navigating vehicle 930 along a route corresponding to the directions received via GPS module 942.

In some embodiments, vehicle sensors 938 may comprise one or more of proximity sensors, ultrasonic sensors, temperature sensors, accelerometers, gyroscopes, pressure sensors, humidity sensors, etc., and control circuitry 932 may monitor vehicle operations, such as navigation, powertrain, braking, battery, generator, climate control, and other vehicle systems. Such communication systems for exchanging information with external devices, networks, and systems, such as cellular, Wi-Fi, satellite, vehicle-to-vehicle communications, infrastructure communication systems, and other communications technologies. Such vehicle systems may acquire numerous data points per second, and from this data may identify or calculate numerous types of vehicle status data, such as location, navigation, environmental conditions, velocity, acceleration, change in altitude, direction, and angular velocity.

FIG. 10 is a flowchart of an illustrative process for adaptive climate control based on thermal imaging, in accordance with some embodiments of the present disclosure. In some examples, the steps outlined within process 1000 are performed by server 110 of FIG. 1. For example, non-transitory memories of one or more components of the server and devices of FIGS. 8 and 9, e.g., storage 914 and control circuitry 911, may store instructions that, when executed by the server and devices of FIGS. 8 and 9 (as described further above with reference to FIGS. 8 and 9), cause execution of the process depicted in FIG. 10. The actions and descriptions of FIG. 10 may be used with any other embodiment of this disclosure. In addition, the actions and descriptions described in relation to FIG. 10 may be done in suitable alternative orders or in parallel to further the purposes of this disclosure.

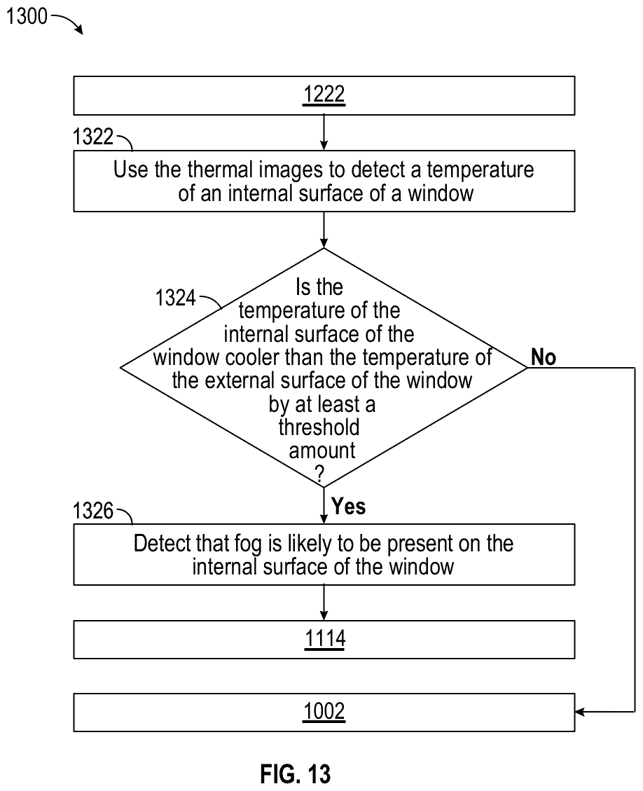

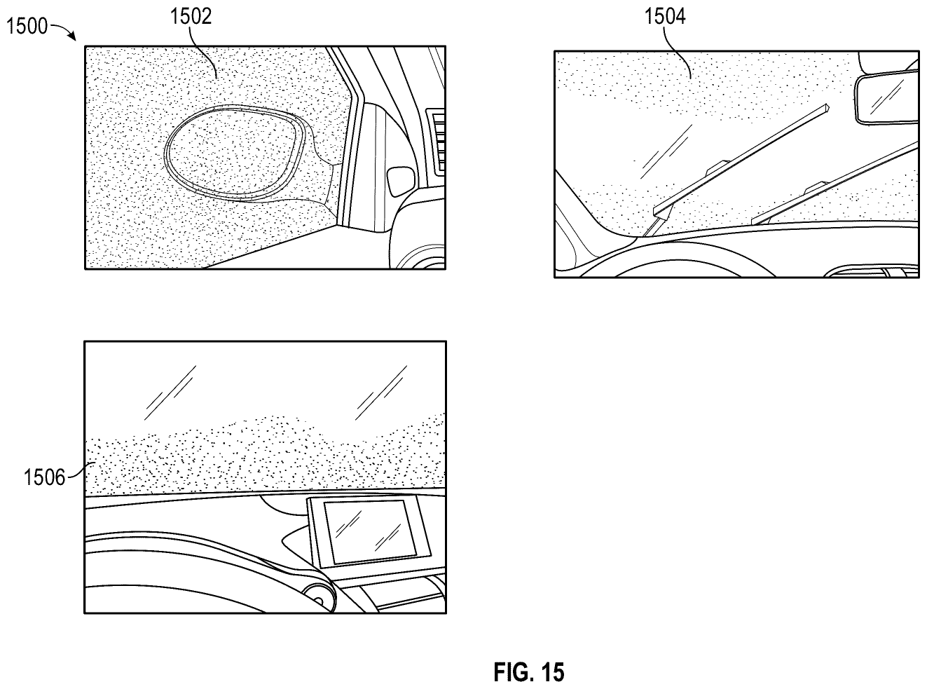

In some embodiments, at 1002, control circuitry, for example, control circuitry 911 of FIG. 9 or control circuitry 932 of FIG. 9 instructs one or more thermal imaging cameras, e.g., thermal imaging cameras 116 of FIG. 1, to capture thermal images of windows, e.g., windows 114 of FIG. 1, of a vehicle, e.g., vehicle 112 of FIG. 1. At 1004, the control circuitry determines whether one of the windows is experiencing condensation conditions. In some embodiments, the control circuitry determines whether one of the windows is experiencing condensation conditions by additionally or alternatively capturing one or more standard images of the interior of the vehicle using a camera and based on the standard images and the thermal images, detecting that fog or frost is currently present on the internal or external surface of at least one of the windows, as described further below with reference to FIG. 15. In some embodiments, the control circuitry determines whether one of the windows is experiencing condensation conditions by detecting that fog is likely to be present on the internal or external surface of one of the windows, as described further below with reference to FIGS. 12 and 13. In some examples, if none of the windows are experiencing condensation conditions, process 1000 returns to 1002. In some embodiments, if at least one of the windows is experiencing condensation conditions, process 1000 proceeds to 1006. At 1006, the control circuitry identifies a climate control adjustment to ameliorate the condensation conditions of the window, as described further below with reference to FIG. 11. At 1008, the control circuitry causes a system of the vehicle to perform the climate control adjustment, as described further below with reference to FIG. 11. In some examples, following process step 1008, process 1000 then returns to 1002. In some embodiments, depending on the condensation conditions, the resources of the system of the vehicle, e.g., the HVAC system, may be prioritized. For example, fog on the driver's side of a windshield will take priority over foggy passenger windows, and therefore, HVAC resources are prioritized to defog for safety reasons.

FIG. 11 is a flowchart of an illustrative process for adaptive climate control based on thermal imaging, in accordance with some embodiments of the present disclosure. In some examples, the steps outlined within process 1100 are performed by server 110 of FIG. 1. For example, non-transitory memories of one or more components of the server and devices of FIGS. 8 and 9, e.g., storage 914 and control circuitry 911, may store instructions that, when executed by the server and devices of FIGS. 8 and 9 (as described further above with reference to FIGS. 8 and 9), cause execution of the process depicted in FIG. 11. The actions and descriptions of FIG. 11 may be used with any other embodiment of this disclosure. In addition, the actions and descriptions described in relation to FIG. 11 may be done in suitable alternative orders or in parallel to further the purposes of this disclosure.

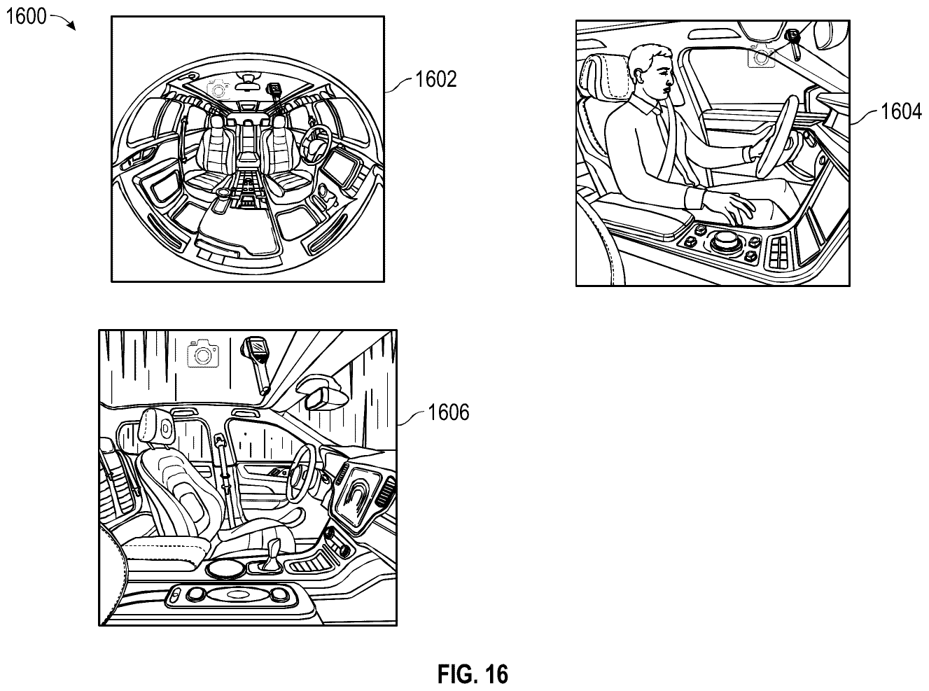

In some embodiments, determining that condensation conditions are likely to be present on the internal or external surface of a window is based on thermal images, as described further below with reference to FIGS. 12 and 13. In some embodiments, determining that condensation conditions are present on the internal or external surface of a window is based on standard images, as described further below with reference to FIG. 16. In some embodiments, following the control circuitry, for example, control circuitry 911 of FIG. 9 or control circuitry 932 of FIG. 9, determining at process step 1004 (as described further above with reference to FIG. 10) that at least one window is experiencing condensation conditions, process 1100, at 1106, determines whether frost is present or likely to be present on the external surface of the windshield of the vehicle, e.g., windshield 118 of vehicle 112 of FIG. 1. In some embodiments, the control circuitry determines whether frost is present on the external surface of the windshield of the vehicle by also capturing one or more standard images of the interior of the vehicle using a camera and based on the standard images and the thermal images, detecting that frost is currently present on the external surface of the windshield, as described further below with reference to FIG. 15. In some embodiments, if frost is present or likely to be present on the external surface of the windshield, process 1100 proceeds to 1108. In some embodiments, if frost is not present or likely to be present on the external surface of the windshield, process 1100 proceeds to 1116.

At 1108, the control circuitry activates the windshield defroster. At 1110, the control circuitry releases anti-icing fluid. At 1112, the control circuitry activates windshield wipers of the vehicle. At 1114, the control circuitry activates the heating function of the air-conditioning portion of the HVAC system of the vehicle and directs airflow towards portions of the windshield where the fog/frost is present or likely to be present. In some examples, following process step 1114, process 1100 returns to process step 1002, as described further above with reference to FIG. 10.

At 1116, the control circuitry determines whether fog is present or likely to be present on the external surface of the windshield. In some embodiments, the control circuitry determines whether fog is present on the external surface of the windshield by also capturing one or more standard images of the interior of the vehicle using a camera and based on the standard images and the thermal images, detecting that fog is currently present on the external surface of the windshield, as described further below with reference to FIG. 15. In some embodiments, the control circuitry determines that fog is likely to be present on the external surface of the windshield using methods described further below with reference to FIG. 12. In some embodiments, if fog is present or likely to be present on the external surface of the windshield, process 1100 proceeds to 1118. In some embodiments, if fog is not present or likely to be present on the external surface of the windshield, process 1100 proceeds to 1120.

At 1118, the control circuitry activates windshield wipers of the vehicle. In some examples, following process step 1118, process 1100 returns to process step 1002, as described further above with reference to FIG. 10.

At 1120, the control circuitry determines whether fog is present or likely to be present on the external surface of a window, e.g., one of windows 114 of vehicle 112, as described further above with reference to FIG. 1. In some embodiments, the control circuitry determines whether fog is present on the external surface of a window by also capturing one or more standard images of the interior of the vehicle using a camera and based on the standard images and the thermal images, detecting that fog is currently present on the external surface of at least one of the windows, as described further below with reference to FIG. 15. In some embodiments, the control circuitry determines whether fog is present or likely to be present on the external surface of a window using methods described further below with reference to FIG. 12. In some embodiments, if fog is present or likely to be present on at least one window, process 1100 proceeds to 1122. In some embodiments, if fog is not present or likely to be present on the external surface of the window, process 1100 proceeds to 1124.

At 1122, the control circuitry opens and closes the side windows of the vehicle intermittently. In some examples, following process step 1122, process 1100 returns to process step 1002, as described further above with reference to FIG. 10.

At 1124, the control circuitry determines whether frost is present or likely to be present on the external surface of a window. In some embodiments, the control circuitry determines whether frost is present on the external surface of a window by also capturing one or more standard images of the interior of the vehicle using a camera and based on the standard images and the thermal images, detecting that frost is currently present on the external surface of at least one of the windows, as described further below with reference to FIG. 15. In some embodiments, if frost is present or likely to be present on the external surface of a window, process 1100 proceeds to 1114. In some embodiments, if frost is not present or likely to be present on the external surface of a window, process 1100 proceeds to 1126.

At 1126, the control circuitry determines whether fog is present or likely to be present on the internal surface of a window. In some embodiments, the control circuitry determines whether fog is present on the internal surface of a window by also capturing one or more standard images of the interior of the vehicle using a camera and based on the standard images and the thermal images, detecting that fog is currently present on the internal surface of at least one of the windows. In some embodiments, the control circuitry determines fog is likely to be present on the internal surface of a window using methods described further below with reference to FIG. 13. In some embodiments, if fog is present or likely to be present on the internal surface of a window, process 1100 proceeds to process step 1114. In some embodiments, if fog is not present or likely to be present on the internal surface of a window, process 1100 returns to process step 1002, as described further above with reference to FIG. 10.

FIG. 12 is a flowchart of an illustrative process for illustrative process for adaptive climate control based on thermal imaging, in accordance with some embodiments of the present disclosure. In some examples, the steps outlined within process 1200 are performed by server 110 of FIG. 1. For example, non-transitory memories of one or more components of the server and devices of FIGS. 8 and 9, e.g., storage 914 and control circuitry 911, may store instructions that, when executed by the server and devices of FIGS. 8 and 9 (as described further above with reference to FIGS. 8 and 9), cause execution of the process depicted in FIG. 12. The actions and descriptions of FIG. 12 may be used with any other embodiment of this disclosure. In addition, the actions and descriptions described in relation to FIG. 12 may be done in suitable alternative orders or in parallel to further the purposes of this disclosure.

In some embodiments, following the actions outlined in process step 1002 in FIG. 10, at 1222, control circuitry, for example, control circuitry 911 of FIG. 9 or control circuitry 932 of FIG. 9, uses the thermal images to detect a temperature of an external surface of a window by detecting and measuring the infrared energy of the external surface of the window and converting that infrared data into an electronic image that shows the apparent surface temperature of the window. At 1224, the control circuitry determines whether the temperature of the external surface of at least one window, e.g., one of the windows 114 of vehicle 112, is lower than a dewpoint of the environment external to the vehicle by at least a threshold amount. In some embodiments, if the temperature of the external surface of at least one window is lower than a dewpoint of the environment external to the vehicle by at least a threshold amount, process 1200 proceeds to 1226. In some embodiments, if the temperature of the external surface of at least one window is not lower than a dewpoint of the environment external to the vehicle by at least a threshold amount, process 1200 returns to 1002, as described further above with reference to FIG. 10. At 1226, control circuitry detects that fog is likely to be present on the external surface of the window. In some examples, following process step 1226, process 1200 proceeds to process step 1122, as described further above with reference to FIG. 11.

FIG. 13 is a flowchart of an illustrative process for adaptive climate control based on thermal imaging, in accordance with some embodiments of the present disclosure. In some examples, the steps outlined within process 1300 are performed by server 110 of FIG. 1. For example, non-transitory memories of one or more components of the server and devices of FIGS. 8 and 9, e.g., storage 914 and control circuitry 911, may store instructions that, when executed by the server and devices of FIGS. 8 and 9 (as described further above with reference to FIGS. 8 and 9), cause execution of the process depicted in FIG. 13. The actions and descriptions of FIG. 13 may be used with any other embodiment of this disclosure. In addition, the actions and descriptions described in relation to FIG. 13 may be done in suitable alternative orders or in parallel to further the purposes of this disclosure.

In some embodiments, following the actions outlined in process step 1222 in FIG. 12, at 1322, control circuitry, for example, control circuitry 911 of FIG. 9 or control circuitry 932 of FIG. 9, uses the thermal images to detect a temperature of an internal surface of a window. At 1324, the control circuitry determines whether the temperature of the internal surface of at least one window, e.g., one of the windows 114 of vehicle 112, is cooler than the temperature of the external surface of the window by at least a threshold amount. In some embodiments, if the temperature of the internal surface of at least one window is cooler than the temperature of the external surface of the window by at least a threshold amount, process 1300 proceeds to 1326. In some embodiments, if the temperature of the internal surface of at least one window is not cooler than the temperature of the external surface of the window by at least a threshold amount, process 1300 returns to 1002, as described further above with reference to FIG. 10. At 1326, control circuitry detects that fog is likely to be present on the internal surface of the window. In some examples, following process step 1326, process 1300 proceeds to process step 1114, as described further above with reference to FIG. 11.

FIG. 14 is a flowchart of an illustrative process for adaptive climate control based on thermal imaging, standard imaging, and physiological states of a user, in accordance with some embodiments of the present disclosure. In some examples, the steps outlined within process 1400 are performed by server 110 of FIG. 1. For example, non-transitory memories of one or more components of the server and devices of FIGS. 8 and 9, e.g., storage 914 and control circuitry 911, may store instructions that, when executed by the server and devices of FIGS. 8 and 9 (as described further above with reference to FIGS. 8 and 9), cause execution of the process depicted in FIG. 14. The actions and descriptions of FIG. 14 may be used with any other embodiment of this disclosure. In addition, the actions and descriptions described in relation to FIG. 14 may be done in suitable alternative orders or in parallel to further the purposes of this disclosure.

In some embodiments, following the actions outlined in process step 1002 in FIG. 10, at 1402, control circuitry, for example, control circuitry 911 of FIG. 9 or control circuitry 932 of FIG. 9, instructs one or more thermal imaging cameras, e.g., the one or more thermal imaging cameras 116 of FIG. 1 to capture at least one thermal image of an interior of the vehicle, e.g., vehicle 112 of FIG. 1. In some embodiments, the control circuitry instructs the thermal imaging cameras to capture images periodically, e.g., at the beginning of a trip, and then at periodic intervals throughout the trip. In some embodiments, the control circuitry instructs the thermal imaging cameras to capture images in response to a user-initiated action, e.g., pressing a button on the steering wheel or dashboard of the vehicle, or issuing a voice command. In some embodiments, the control circuitry instructs the thermal imaging cameras to capture images in response to drastic changes in temperature throughout the trip. In some embodiments, the control circuitry instructs the thermal imaging cameras to capture images based on receiving data over a connected network of vehicles indicating that there are other vehicles in the area experiencing condensation conditions.

At 1404, the control circuitry captures standard images of the interior of the vehicle using a camera. At 1406, the control circuitry generates, based on the at least one thermal image and the standard images, an occupancy map identifying locations of passengers within the vehicle and body temperatures of the passengers within the vehicle. At 1408, the control circuitry determines, based on user preferences and historical data, an ideal body temperature for each passenger within the vehicle.

In some embodiments, at 1410, the control circuitry determines whether there are differences between the body temperatures of the passengers and the ideal body temperatures of the passengers. In some examples, if the control circuitry determines there are differences between the body temperatures of the passengers and the ideal body temperatures of the passengers, process 1400 proceeds to 1412. In some examples, if the control circuitry determines there are not differences between the body temperatures of the passengers and the ideal body temperatures of the passengers, process 1400 returns to 1402.

At 1412, the control circuitry determines, based on the occupancy map and the differences between the body temperatures of the passengers and the ideal body temperatures of the passengers, passenger climate control adjustments to address the differences for each area of the occupancy map, as described further below with reference to FIG. 16. At 1414, the control circuitry causes the vehicle to perform the climate control adjustments. In some examples, following process step 1414, process 1400 returns to 1402.

FIG. 15 shows illustrative examples of condensation conditions present on windows of a vehicle, in accordance with some embodiments of the present disclosure. In some embodiments, system 1500 includes standard image of fog forming on the exterior of the windows on the driver's side of a vehicle 1502, standard image of frost forming on the external surface of the windshield of a vehicle 1504, and standard image of fog forming on the external surface of the windshield of a vehicle 1506. In some embodiments, based on standard image 1502, a server, e.g., server 110 of FIG. 1, controls the windows, e.g., side windows of windows 114 of FIG. 1, of the vehicle, e.g., vehicle 112 of FIG. 1, to open and close intermittently, reducing the fog. In some embodiments, based on standard image 1504, the server activates the windshield defroster and heater through the air-conditioning system of the vehicle and directs a stream of hot air toward the frosted area while applying anti-icing fluid and utilizing wipers to ensure the frost is removed. In some embodiments, based on standard image 1506, the system (e.g., system 100) activates windshield wipers of the vehicle to remove moisture, ensuring clear visibility.

FIG. 16 shows illustrative examples of thermal images of the interior of vehicles and passengers for adaptive climate control, in accordance with some embodiments of the present disclosure. In some embodiments, system 1600 includes a thermal image of a pre-occupancy state of a vehicle interior 1602, a thermal image depicting rapid comfort adjustment for cold hands, feet, and face in a vehicle 1604, and a thermal image depicting preemptive climate control activation for de-icing windows and warming seats 1606. Thermal image 1602 shows a vehicle's interior before passengers' entry, displaying the internal initial temperature distribution throughout the cabin, seats, and armrests and demonstrating the system's anticipation of adjusting to each passenger's comfort needs. Thermal image 1604 shows a person sitting in a car equipped with the adaptive climate control system. In some embodiments, the person in thermal image 1604 has cold hands, a cold face, and cold lower legs. In some embodiments, in response, the vehicle's system activates heated armrests and the heated steering wheel, and blows warm air onto the hands, legs, and face of the person to raise their temperature quickly. Thermal image 1606 highlights the condition of the vehicle with frozen windows and cold seats. In some embodiments, the vehicle in thermal image 1606 is expected to be used by the owner and passengers in the near future (e.g., within 30 minutes). In some embodiments, in anticipation, the system (e.g., system 100) activates the climate control system, focuses airflow on defrosting the windows, and initiates seat heating to prepare the car for a comfortable journey.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving one or more thermal images of one or more windows of a vehicle, wherein the one or more thermal images are captured using one or more thermal imaging cameras;
determining, based on the one or more thermal images, whether the one or more windows are experiencing condensation conditions;
based on determining that the one or more windows are experiencing the condensation conditions, identifying a climate control adjustment to ameliorate the condensation conditions of the one or more windows of the vehicle; and
causing a system of the vehicle to perform the climate control adjustment.

2. The method of claim 1, wherein:
the one or more windows of the vehicle comprise a windshield of the vehicle;
the condensation conditions comprise fog present or likely to be present on an external surface of the windshield of the vehicle; and
causing the system of the vehicle to perform the climate control adjustment comprises activating windshield wipers of the vehicle.

3. The method of claim 1, wherein:
the one or more windows of the vehicle comprise a windshield of the vehicle;
the system of the vehicle is a heating, ventilation, and air-conditioning (HVAC) system;
the condensation conditions comprise frost present or likely to be present on an external surface of the windshield of the vehicle; and
causing the HVAC system of the vehicle to perform the climate control adjustment comprises one or more of activating a windshield defroster, activating a heating function of an air-conditioning portion of the HVAC system of the vehicle and directing airflow towards portions of the windshield where frost is present or is likely to be present, releasing anti-icing fluid, or activating windshield wipers.

4. The method of claim 1, wherein:
the one or more windows of the vehicle comprise a rear window of the vehicle;
the system of the vehicle is a heating, ventilation, and air-conditioning (HVAC) system;
the condensation conditions comprise fog or frost present or likely to be present on an external surface of the rear window of the vehicle; and
causing the HVAC system of the vehicle to perform the climate control adjustment comprises one or more of releasing anti-icing fluid, activating a rear window wiper, or activating heating strips built into the rear window for defogging and deicing.

5. The method of claim 1, wherein:
the one or more windows of the vehicle comprise one or more side windows of the vehicle;
the condensation conditions comprise fog present or likely to be present on an external surface of a side window of the one or more side windows; and
causing the system of the vehicle to perform the climate control adjustment comprises causing opening and closing of the one or more side windows intermittently.

6. The method of claim 1, wherein:
the one or more windows of the vehicle comprise one or more side windows of the vehicle;
the system of the vehicle is a heating, ventilation, and air-conditioning (HVAC) system;
the condensation conditions comprise fog present or likely to be present on an internal surface of a side window of the one or more side windows; and
causing the HVAC system of the vehicle to perform the climate control adjustment comprises activating a heating function of an air-conditioning portion of the HVAC system of the vehicle and directing airflow towards portions of the one or more side windows where internal fog is present or is likely to be present.

7. The method of claim 1, wherein:
the one or more windows of the vehicle comprise one or more side windows of the vehicle;
the system of the vehicle is a heating, ventilation, and air-conditioning (HVAC) system;
the condensation conditions comprise frost present or likely to be present on an external surface of a side window of the one or more side windows; and
causing the HVAC system of the vehicle to perform the climate control adjustment comprises activating a heating function of an air-conditioning portion of the HVAC system of the vehicle and directing airflow towards portions of the side window where frost is present or likely to be present.

8. The method of claim 1, wherein:
the determining whether the one or more windows are experiencing the condensation conditions comprises:
using the one or more thermal images to detect a temperature of an external surface of a window of the one or more windows of the vehicle; and
detecting that fog is likely to be present on the external surface of the window based on determining that the temperature of the external surface of the window is lower than a dewpoint of an environment external to the vehicle by at least a threshold amount.

9. The method of claim 1, wherein:
the determining whether the one or more windows are experiencing the condensation conditions comprises:
using the one or more thermal images to detect a temperature of an external surface of a window of the one or more windows;
using the one or more thermal images to detect a temperature of an internal surface of the window; and
detecting that fog is likely to be present on the internal surface of the window based on determining the temperature of the internal surface of the window is cooler than the temperature of the external surface of the window by at least a threshold amount.

10. The method of claim 1, wherein:
the determining whether the one or more windows are experiencing the condensation conditions comprises:
receiving one or more standard images of the interior of the vehicle, wherein the one or more standard images are captured using a camera; and
detecting, based on the one or more standard images and the one or more thermal images, that fog or frost is present on the internal or external surface of a window of the one or more windows.

11. The method of claim 10, wherein the detecting, based on the one or more standard images and the one or more thermal images, that the fog or frost is present on the internal or external surface of the window of the one or more windows is based on one or more of a shape of one or more water droplets on the one or more windows of the vehicle, how light interacts with the one or more water droplets on the one or more windows of the vehicle, or temperature differences across the one or more windows of the vehicle.

12. The method of claim 1, wherein the climate control adjustment for condensation conditions present on at least one of a driver's side of a windshield or a driver's side window is prioritized for execution over condensation conditions present on at least one of a passenger's side of the windshield or a passenger's side window.

13. The method of claim 1, wherein the determining whether the one or more windows are experiencing the condensation conditions is executed using a machine learning model, and wherein the determining the climate control adjustment to ameliorate the condensation conditions of the one or more windows of the vehicle is executed using a machine learning model.

14. The method of claim 1, further comprising:
receiving at least one thermal image of an interior of the vehicle, wherein the one or more thermal images are captured using the one or more thermal imaging cameras;
receiving one or more standard images of the interior of the vehicle, wherein the one or more standard images are captured using a camera; and
generating, based on the at least one thermal image and the one or more standard images, an occupancy map identifying locations of passengers within the vehicle and body temperatures of the passengers within the vehicle.

15. The method of claim 14, further comprising:
determining, based on user preferences and historical data, an ideal body temperature for each passenger of the passengers within the vehicle;
determining a difference between a body temperature of the each passenger of the passengers within the vehicle and the ideal body temperature for the each passenger of the passengers within the vehicle;
determining, based on the occupancy map and the difference between the body temperature of the each passenger of the passengers within the vehicle and the ideal body temperature for the each passenger of the passengers within the vehicle, one or more passenger climate control adjustments to address the difference for each area of the occupancy map; and
causing the system of the vehicle to perform the one or more passenger climate control adjustments.

16. The method of claim 15, wherein the causing the system of the vehicle to perform the one or more passenger climate control adjustments comprises one or more of directing or stopping flow of air through a controllable vent to an area of the occupancy map corresponding to a particular passenger or activating a heating coil of a heated seat occupied by the particular passenger.

17. The method of claim 14, further comprising:
receiving a current body temperature and an ideal body temperature of a potential passenger who is not yet in the vehicle;
determining, based on a current temperature within the vehicle, the current body temperature of the potential passenger, and the ideal body temperature of the potential passenger, a passenger climate control adjustment; and
causing the system of the vehicle to perform the passenger climate control adjustment.

18. A system comprising:
control circuitry configured to:
receive one or more thermal images of one or more windows of a vehicle, wherein the one or more thermal images are captured using one or more thermal imaging cameras;
determine, based on the one or more thermal images, whether the one or more windows are experiencing condensation conditions;
based on determining that the one or more windows are experiencing the condensation conditions, identify a climate control adjustment to ameliorate the condensation conditions of the one or more windows of the vehicle; and
cause a system of the vehicle to perform the climate control adjustment.

19. The system of claim 18, wherein:
the one or more windows of the vehicle comprise a windshield of the vehicle;
the condensation conditions comprise fog present or likely to be present on an external surface of the windshield of the vehicle; and
the control circuitry is configured to cause the system of the vehicle to perform the climate control adjustment, by activating windshield wipers of the vehicle.

20. The system of claim 18, wherein:
the one or more windows of the vehicle comprise a windshield of the vehicle;
the system of the vehicle is a heating, ventilation, and air-conditioning (HVAC) system;
the condensation conditions comprise frost present or likely to be present on an external surface of the windshield of the vehicle; and
the control circuitry is configured to cause the HVAC system of the vehicle to perform the climate control adjustment by one or more of activating a windshield defroster, activating a heating function of an air-conditioning portion of the HVAC system of the vehicle and directing airflow towards portions of the windshield where frost is present or is likely to be present, releasing anti-icing fluid, or activating windshield wipers.

21.-85. (canceled)
